(19) United States
(12) Patent Application Publication
(10) Pub. No.: US 2007/0056009 A1
(43) Pub. Date: Mar. 8, 2007

(54) System and method for viewing and controlling a personal computer using a networked television

(76) Inventors: Michael Spilo, Greenwich, CT (US); Jonathan Daub, New York, NY (US)

Correspondence Address: DARBY & DARBY P.C., P. O. BOX 5257, NEW YORK, NY, 10150-5257, US

(21) Appl. No.: 11/211,184

(22) Filed: Aug. 23, 2005

(51) Int. Cl. H04N 7/16; H04N 7/173

(52) U.S. Cl. 725/132; 725/140; 725/152; 725/131

(57) ABSTRACT

Presented are systems and methods for controlling a PC from an interactive TV display. The system includes a network which interconnects a TV set-top-box (STB) to a PC. The STB includes a network interface so as to communicate with the network, a remote control receiver, a display controller, and a CPU. A remote control transmits a user's commands to the remote control receiver in the STB, which forwards the commands to a client software application resident in the PC. The client software interprets the commands and causes the PC to perform various programmatic steps. Images of the PC screen display are sent across the network to the STB from the PC by the client software application, where the display controller displays these images on the TV. An interactive virtual mouse, controllable by commands transmitted from the remote control, is superimposed on the images being displayed on the TV.

### FIELD OF INVENTION

The present invention relates to displaying and controlling a personal computer (PC) screen, and in particular to displaying and controlling the PC screen by user interaction through a network-connected remote television.

### BACKGROUND OF THE INVENTION

PC remote control is a well known function, dating back to teletype terminals used to remotely interact with various computers. Other known methodologies include PC-to-PC access using dedicated software such as “PC Anywhere,” available from Symantec Corporation, Cupertino, Calif. A more recent trend is to provide remote internet access to a PC using software such as “GoToMyPC,” available from Citrix Online, a division of Citrix Systems, Inc., Santa Barbara, Calif.

To control the functions of the remote PC, these programs and their ilk require a PC which includes at least a keyboard and usually also a mouse. Furthermore, these programs are limited to operate in environments where the host, or viewing computer, is similar in capabilities and processing power to the target, or remotely controlled, computer. Additionally, these types of remote control programs are designed to operate over low bandwidth internet or telephone connection. Thus, requiring a complex bidirectional communication interface that provides mouse and keyboard commands in one direction, while providing screen change data in the other direction.

With the advent of home networking several methods for accessing the Internet and providing other PC type functions from a television have evolved. These involve providing programs that function like a personal computer on a television set top box. Known examples of interactive set top television boxes include Microsoft's WebTV, American Online's AOLTV, Philips Electronics' iPronto, and Sony's TV Anywhere.

These devices provide Internet access, in some cases e-mail capability, and even some rudimentary computing functions packaged in a set top box for use with a TV. Oftentimes the functionality provided by these set top boxes are incompatible with many Internet content pages which rely on full featured Internet browsers. These inexpensive set top devices are generally limited in their performance and capabilities due to the limited nature of the processors used as their controller.

A PC-to-TV converter is a third class of device that has evolved which provides on-TV access to PCs. This class of device converts the PC's video output to a format suitable for connection to a TV input. Some of these devices require a local hard-wired connection, while others operate wirelessly by transmitting the PC video output to a remote location. Examples of this type of device are various PC Video cards such as the ATI TV Wonder which include a TV S-Video or composite output; along with devices known as “Scan Converters” such as are available from Audio Authority, Lexington, Ky. A scan converter converts PC format output to TV format output for direct cable connection. There are also similar wireless devices such as the Terk Leapfrog line of transmitters and receivers available from TERK Technologies, Commack, N.Y.

PC-to-TV devices have several problems. First, they are of limited range. Wired versions provide local access within about 20 or 30 feet due to cable losses, the wireless versions have greater range, but are prone to interference. They are designed for only point to point video transmission, and additional hardware is required split the video to feed multiple locations. Control in the reverse direction is limited, transmitting only standard IR signals back to the source. These IR signals are generally insufficient to control the PC. Finally, the technology only supports a single resolution or zoom ratio. If the TV resolution is of a lower resolution than the PC, the PC must be set to the resolution of the TV, or the signal must be scaled down providing limited readability of the PC screen on the TV.

Missing from the art is a PC-to-TV interface that is wideband, provides dual directional transmission of control and data, and supports multi-resolution display with zoom function on the TV. The present invention can satisfy one or more of these and other needs.

### SUMMARY OF THE INVENTION

In accordance with an aspect of the invention, a system controls a PC from an interactive TV display. The system includes a network which interconnects at least one set-top-box (STB), that is in communication with the TV, to at least one PC. The STB includes a network interface for communicating with the network, a remote control receiver, a display controller, and a CPU. The PC includes a client software application which is in communication with the STB CPU, across the network. In response to a user's entry, a remote control unit transmits commands to the remote control receiver in the STB, and the STB communicates these commands across the network to the client software application resident in the PC. Images of the PC screen display are sent across the network to the STB from the PC by the client software application, where the display controller displays these images on the TV.

In another aspect of the invention, the client software interprets the commands sent from the STB and causes the PC to perform various programmatic steps.

In yet another aspect of the invention, an interactive virtual mouse, controllable by commands transmitted from the remote control, is superimposed on the TV's displayed images.

In still another aspect of the invention, the client software application creates a virtual desktop environment on the PC, where the virtual desktop environment has a resolution which matches the resolution of the TV, and the PC executes programs within the virtual desktop.

In still further aspects of the present invention, a method controls a PC by sending a user's commands entered in a remote control unit to a client software application. The commands are interpreted by the software application to cause the PC to execute various programmatic steps.

These and other aspects, features, steps and advantages can be further appreciated from the accompanying drawing Figures and description of certain illustrative embodiments.

### BRIEF DESCRIPTION OF THE DRAWING FIGURES

FIG. 1 shows a schematic diagram of a system for an embodiment of the invention;

FIG. 2 illustrates a component diagram for a portion of the embodiment shown in FIG. 1; and

FIG. 3 depicts a “screen shot” of a PC screen as displayed on a TV in accordance with an embodiment of the present invention.

### DETAILED DESCRIPTION OF ILLUSTRATIVE EMBODIMENTS

By way of overview and introduction, presented and described are embodiments of a PC-to-TV interface that is dual directional and supports full PC function access at the TV through a set-top box. The set-top box has a low cost design and can be achieved with a limited processor. Available features include multiple zoom options for improved readability of the PC screen at the TV, enhanced PC control through the use of IR technology, and expanded operating range implemented by standard networking technology.

In one embodiment, the low-cost set top box (STB) renders bitmap images of a PC screen in TV form by incorporating a CPU with an On-Screen-Display controller. The STB also contains a network connection which uses standard wired or wireless networking protocols, and a remote control receiver with IR and/or RF capability to receive signals from a remote control.

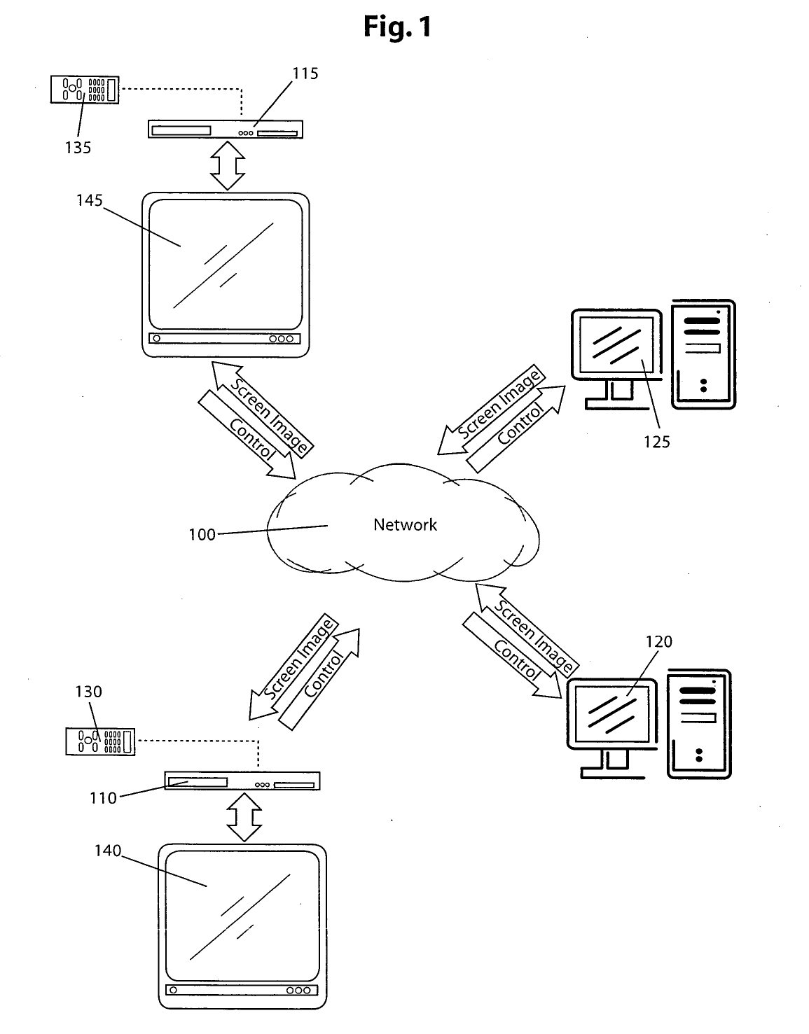

With reference to FIG. 1, illustrated is a schematic diagram of a system for an embodiment of the invention. A network 100 is interconnected with multiple STBs 110, 115 and multiple PCs 120, 125. As described in detail below, a screen image is uploaded from a PC 120, 125 and downloaded to a STB 110, 115. In this embodiment the STB receives user commands via remote control 130, 135. The STB 110, 115 processes these received user commands and sends the commands via the network 100. The commands are then received by client software on the PCs 120, 125. The STB 110, 115 is capable of controlling one of several PCs, and displaying that controlled PC's screen image on the TV 140, 145.

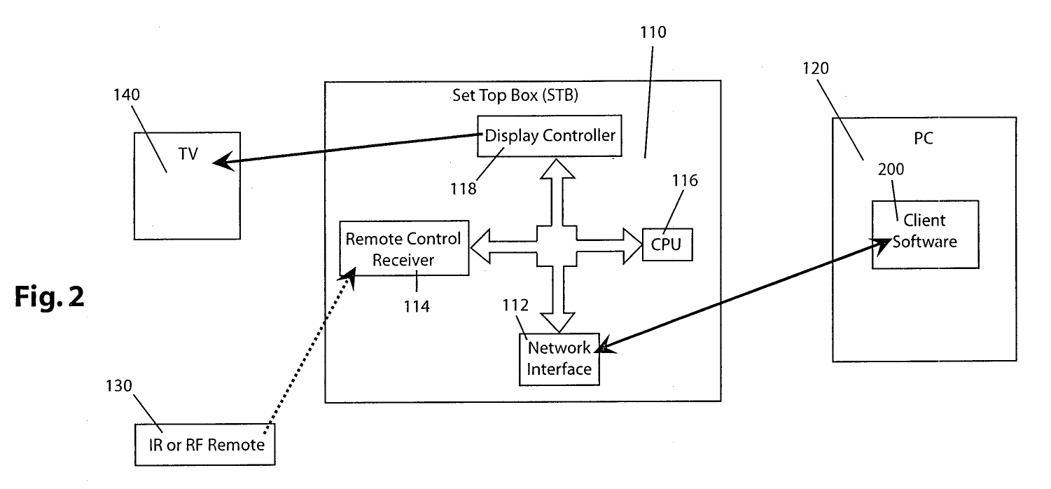

FIG. 2 depicts is a component diagram for the STB 110 of the embodiment shown in FIG. 1. A client application program 200 is resident on each computer that is connected to the STB 110. The client application program communicates with the STB over the network 100. The STB identifies to the user, using an on-screen menu display which computers are available for control through the STB. The user selects the computer to be controlled by depressing keys on the remote control 130. The STB connects to the client software 200 on the desired computer 120 using traditional network communication protocols. The client software captures and then transmits an image of all or part of the computer's screen image to the STB in a format capable of being displayed by the STB on the TV—e.g., a bitmap image. The invention is not limited in the possible formats capable of being displayed. However because there is a lot of network bandwidth, and so as not to over burden the computing power at the receiving end, in a preferred embodiment the PC converts the screen directly to the native display format of the STB prior to transmission.

The client software 200 can optionally scale the image prior to transmitting it, or optionally transmit only portions of the screen for “zoomed in” display. Displaying portions or zooming the PC screen image is done in response to user commands received over the RF/IR ling to the STB.

As is known in the art, with sufficient processing power at the client software end, the screen image can be sent as a series of “deltas”—i.e., transmitting only those portions of the screen that have changed since the last transmission. Screen images can be optionally compressed before transmission to the STB to reduce transmission time. The delta comparison and/or compression depends on the speed at which the image can be compared/compressed versus. the speed of the network. Compressed screen images can be transmitted faster with less bandwidth, thus, increased network throughput is also a consideration. In many home-network environments compression is unnecessary because of the available high bandwidth (11 Mbps or more) of the typical home network.

With reference to FIG. 2, the STB 110 includes a network interface 112, a remote control receiver 114, a CPU 116, and a display controller 118. These internal components of the STB are interconnected by an internal bus, or may be integrated in a System-on-Chip (SoC) design. System-On-Chip design allows the design of single chips containing embedded cores executing software in addition to containing classical on-board hardware. The remote control receiver 114 senses the user commands transmitted from the user via the remote control 130. These commands are communicated to the CPU 116 across the internal bus. The display controller 118 receives the screen image from the CPU after it has been processed and formatted for display. The output of the display controller is sent to the TV 140 in a protocol format recognizable by the TV. These recognizable formats are, for example, NTSC in the United States or PAL and SECAM in Europe; S-type signal, digital format video standards for PCs (VGA, SVGA, XGA, SXGA, and UXGA).

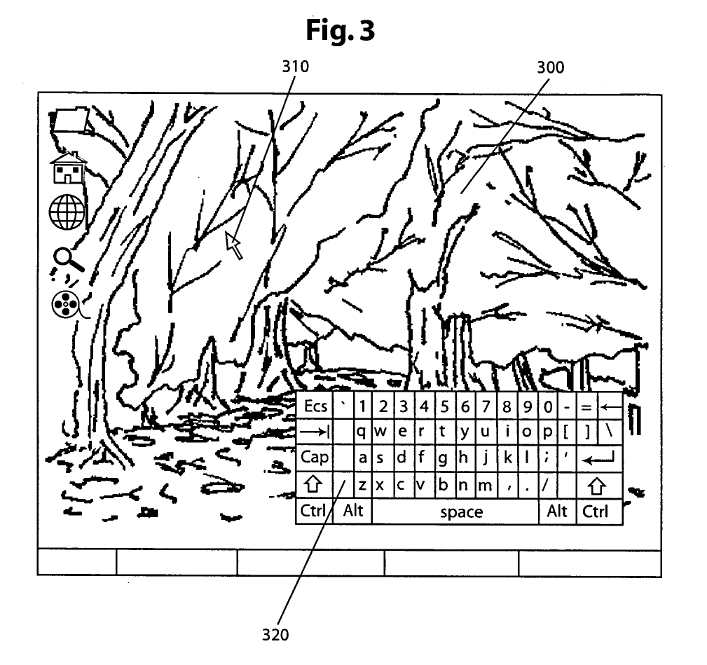

The STB then displays the screen image as a still image on the television using its on-screen display capability. FIG. 3 is a “screen shot” 300 of a PC screen as displayed on a TV in accordance with an embodiment of the present invention The “screen shot” includes a virtual mouse pointer 310 and a pop-up keyboard 320. The user can then use the remote control to send commands back to the computer.

The system on the TV displays a virtual “mouse” pointer 310 which is controlled by left/right/up/down navigation keys on the remote allowing the user to perform point-and-click functions. The system also provides a “pop-up” keyboard 320 to ease entry of text. The pop up keyboard display appears on the TV screen and allows the user to pick keys by selecting from a virtual keyboard using a highlight cursor.

In one embodiment, the keys on the remote control 130 are customizable to provide computer specific functions. This permits even a simple remote with a limited number of keys, for one-hand operation, to allow for extensive control of the PC. As shown in Table I, below, special computer functions are mapped to particular keys on the remote control. Some remote keys simulate single keyboard key presses such as “Enter;” other keys simulate mouse functions such as left and right mouse clicks; while still other keys perform specific programmatic functions such as “Launch Browser,” “show keyboard,” or “Zoom screen.”

TABLE I

| Key | Action |
|---|---|
| RF Joystick | Move mouse |
| RF L/R Select | Left/Right click |
| IR select | Left mouse click |
| IR Info | Right Click |
| Ch Down | Zoom Out |
| Ch Up | Zoom In/region |
| Stop | Close (Alt-F4) |
| Play | Switch (Alt-Tab) |
| Fast Forward | Tab |
| Rewind | Back Tab |
| Numeric | Multitap (e.g. 2, 2 = b) |
| Pause | Show keyboard |
| Guide | Alt (activates menu) |
| RF Up | Scroll up |
| RF Down | Scroll down |
| IR Arrows | Nudge mouse |
| Skip Forward | Next/Alt → |
| Skip Back | Back/Alt [symbol] |
| * | Backspace |
| # | Enter |
| A | Launch browser |
| B | Launch e-mail |
| C | Launch IM |
| D | Launch Word |
| E | Launch Excel |
| F | Show Favorites |
| H | Browser Home |

Full and convenient control of the computer can be achieved with as few as 20 keys. The addition of a numeric keypad and/or a joystick to the remote 130 results in an even more user friendly embodiment.

The zoom function in the current implementation zooms the PC screen image as follows: the “Zoom out” key zooms the PC screen so that the entire PC screen is visible on the TV screen. The “Zoom in” key pressed once zooms the screen so that the Portion of the PC screen which can be mapped pixel to pixel (i.e. no zoom one to one resolution) onto the TV display is shown, and successive presses of the zoom key switch between successive regions of the screen at a one-to-one no zoom, starting with the upper left of the PC screen. In an embodiment, an image processing algorithm processes one-to-one chunks of the PC screen image which are in the native screen size of the TV. For example, if the PC screen is 1024×768 pixels and the TV is 640×420 pixels (the current resolution under the NTSC TV standard), the algorithm would take the 640×420 matrix of pixels surrounding the cursor and convert it to the format used by the display controller (e.g., a simple RGBA format with 32 bits per pixel).

A further aspect of the invention allows the PC Client Software 200 to create a “virtual desktop” in which the client software creates a simulated graphical environment in the PC which is not necessarily shown on the PC screen. In this mode, the PC's simulated “virtual desktop” can be sized to match the TV screen size. This eliminates the need to provide a zoom function, but also limits the amount of information that is readily available to the user, since the zoom function allows the user to quickly hop between sections of the screen.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one described embodiment to another are also fully intended and contemplated. The invention is defined solely with regard to the claims appended hereto, and equivalents of the recitations therein.

We claim:

1. A system for controlling a PC from an interactive TV display comprising:
a network interconnecting at least one set-top-box (STB), that is in communication with the TV, and at least one PC;
the STB including a network interface, a remote control receiver, a display controller, and a CPU;
a remote control unit in communication with the remote control receiver; and
a client software application resident in the PC, the client software application in communication, across the network, with the STB CPU;
wherein the remote control transmits commands to the remote control receiver in the STB, and the STB communicates the commands across the network to the client software application.

2. The system of claim 1, wherein the client software application sends images of the PC screen display across the network to the STB, and the display controller displays these images on the TV.

3. The system of claim 2, wherein the images include portions of the PC screen display which have changed since the previous transmission.

4. The system of claim 2, wherein the client software application sends said images one of periodically and after a change occurs in the PC screen display.

5. The system of claim 4, wherein the images include only portions of the PC screen display which have changed since the previous transmission.

6. The system of claim 2, wherein an interactive virtual mouse pointer is superimposed on the bitmap images of the PC Screen by the STB.

7. The system of claim 6, wherein the superimposed mouse pointer is controllable by commands transmitted from the remote control.

8. The system of claim 1, wherein the client software application interprets the communicated commands and causes the PC to perform various programmatic steps in accordance with these communicated commands.

9. The system of claim 8 wherein said programmatic steps simulate a mouse click to software running on the PC.

10. The system of claim 8, wherein said programmatic steps include simulating a keyboard keystroke.

11. The system of claim 8, wherein said programmatic steps include causing the PC to start executing a particular program.

12. The system of claim 11, wherein said program is an Internet browser resident in the PC.

13. The system of claim 11, wherein said program is an e-mail client resident in the PC.

14. The system of claim 8, wherein said programmatic steps include sending an inter-program message on the PC.

15. The system of claim 2, wherein the images of the PC screen display are first reduced or expanded to fit on the TV display size.

16. The system of claim 2, wherein the images of the PC screen display are cropped to fit the TV display size.

17. The system of claim 16, wherein the cropping is centered around the current location of the virtual mouse

18. The system of claim 16, wherein the cropping represents one of several consecutive sections of the screen, wherein the virtual mouse pointer is repositioned within the cropped region, and successive “zoom” operations move the display between the consecutive regions.

19. The system of claim 2, wherein an interactive virtual keyboard is superimposed on the images of the PC screen display by the STB.

20. The system of claim 1, wherein the client software application is operable to create a virtual desktop environment on the PC, the virtual desktop environment having a resolution which matches the resolution of the TV; and
wherein the PC is operable to execute programs within said virtual desktop.

21. The system of claim 20, wherein the client software application interprets the communicated commands and causes the PC to perform various programmatic steps in accordance with these communicated commands.

22. The system of claim 21 wherein said programmatic steps simulate a mouse click to software running on the PC.

23. The system of claim 21, wherein said programmatic steps include simulating a keyboard keystroke.

24. The system of claim 21, wherein said programmatic steps include causing the PC to start executing a particular program.

25. A method of controlling a PC from an interactive TV display, comprising the steps of:
interconnecting, on a network, a PC with a STB that is in communication with the TV;
transmitting commands, across the network, from the STB to the PC;
receiving the commands at the PC, and forwarding the commands to a client software application resident in the PC;
sending data images of the PC screen display across the network to the STB; and
displaying the images on the interactive TV.

26. The method of claim 25, wherein prior to the transmitting step, the method further comprises the step of broadcasting the commands, from a remote control unit to the STB.

27. The method of claim 25 wherein the sending step further comprises repeating the step of sending the PC screen display images when the images have changed.

28. The method of claim 27, wherein the sent images are only those portions of the PC screen display which have changed.

29. The method of claim 25, further comprising the steps of:
superimposing an interactive virtual mouse pointer on the images displayed on the TV; and
controlling the interactive virtual mouse pointer with commands sent from a remote control unit to the STB.

30. The method of claim 25, further comprising the steps of:
interpreting, by the client software application, the received commands; and
causing the PC to perform various programmatic steps in accordance with the interpreted commands.

31. The method of claim 25, further comprising the steps of:
creating, by the client software application, a virtual desktop environment on the PC;
and executing, by the PC, programs within the virtual desktop.
